(19) United States
(12) Patent Application Publication
(10) Pub. No.: US 2026/0011152 A1
(43) Pub. Date: Jan. 8, 2026

(54) SYSTEM AND METHOD FOR MONITORING LOOSE WASTE COLLECTION ENCLOSURES

(71) Applicant: AKANTHAS, TOULOUSE (FR)

(72) Inventors: Viviana CONTRERAS MORENO, TOULOUSE (FR); Nicolas JAOUEN, TOULOUSE (FR)

(73) Assignee: AKANTHAS, TOULOUSE (FR)

(21) Appl. No.: 18/992,176

(22) PCT Filed: Jul. 4, 2023
(86) PCT No.: PCT/EP2023/068359

§ 371 Date: Jan. 7, 2025

(30) Foreign Application Priority Data
Jul. 7, 2022 (FR) FR2206935

(51) Int. Cl. G06V 20/52; G06T 7/62; G06V 10/12; G06V 10/74; G06V 10/764; G06V 10/774; G06V 10/94

(52) U.S. Cl. CPC G06V 20/52; G06T 7/62; G06V 10/12; G06V 10/761; G06V 10/764; G06V 10/774; G06V 10/95; G06T 2207/20081; G06T 2207/30232

(57) ABSTRACT

The invention relates to a system for monitoring a loose waste collection enclosure (30) comprising: an image acquisition camera; an image processing unit (100); characterized in that said processing unit comprises at least one module for detecting each collection enclosure present in said acquired images based on a first trained machine learning model; a module for determining the type of waste present in each image portion detected as being a collection enclosure based on a second trained machine learning model; a module for computing a filling rate of each collection enclosure by analyzing said enclosure images detected by said enclosure detection module.

### TECHNICAL FIELD OF THE INVENTION

The field of the invention is that of industrial and commercial waste management, in particular that of monitoring and tracking industrial and commercial waste collection enclosures. The invention more specifically relates to a system and a method for monitoring loose waste collection enclosures, in particular industrial and commercial waste.

### TECHNOLOGICAL BACKGROUND

Economic and industrial activities generate more than 59,400 tons of waste every minute throughout the world, which represents more than 90% of the generated waste.

The problem of collecting and managing this industrial and commercial waste therefore poses a significant challenge, both economically and environmentally, and collection entails numerous operational challenges.

It is clear from field studies that 80% of the bins for collecting industrial or commercial waste are over-loaded or under-loaded, which in both cases poses specific problems, particularly related to the transportation of these bins. Indeed, the current regulations stipulate tonnages for waste transportation, which in practice are often exceeded when the bins are over-loaded. When the bins are under-loaded, their transportation results in an unnecessary movement, thereby increasing the costs and the carbon footprint involved in their collection.

Irrespective of the problems involved in transporting over-loaded or under-loaded bins, it is clear from field studies that 50% of the collected waste is incorrectly sorted or is contaminated by other materials.

Therefore, a requirement exists for the provision of a solution for monitoring the industrial and commercial waste collection areas in order to be able to use the transportation vehicles only when the bins are filled to their nominal collection level and/or to be able to detect any sorting errors in the collection area.

Hereafter, a “waste collection enclosure” denotes a loose waste storage space, before it is transported to a reprocessing, recycling or incineration center. These collection enclosures are generally arranged in the vicinity of the waste production or collection site (factory, warehouse, workshop, landfill site, etc.). By way of a non-limiting example, a collection enclosure within the meaning of the invention is a waste container, a collection bin, a cell of a landfill site, a collection pit of a waste storage center, etc., whose content (and optionally the container) has to be picked up by a transportation vehicle when this enclosure is full. Therefore, a waste collection enclosure is a defined space intended for receiving waste.

Throughout the text, a “waste collection area” denotes a geographical area including one or more waste collection enclosures within the meaning of the invention.

Solutions already exist for monitoring the filling level of a waste container.

One of these known solutions implements an ultrasonic sensor arranged on the container and oriented toward the bottom of the container so as to be able to measure the distance separating the sensor from the waste housed in the container. As soon as the measured distance is less than a predetermined distance, the container is considered to be full and its pickup is organized. This solution cannot be adapted to open collection areas, of the landfill cell or open bin type. Furthermore, this solution does not allow the type of collected waste to be detected and therefore does not allow any collection errors to be detected. This solution also proves to be ineffective if the container is not uniformly filled. In particular, if bulky waste is located under the sensor, the system will consider the container to be full while the rest of the container may be waste free. Finally, this solution involves equipping all the containers, which can prove to be expensive and not very feasible, notably when the waste producer leases collection bins from an outside provider, with said provider not necessarily anticipating equipping all these bins with such a solution.

Document U.S. Pat. No. 10,943,356 describes another known solution that implements an image acquisition camera instead of the ultrasonic sensor. This camera is housed in a container and is associated with image analysis and processing software. Like the previous solution, one of the disadvantages of this solution is that it cannot be adapted to collection areas of the landfill cell or open bin type. Furthermore, this solution does not allow the type of collected waste to be detected and therefore does not allow any collection errors to be detected. Finally, this solution involves equipping all the containers, which can prove to be expensive and not very feasible, notably when the waste producer leases collection bins from an outside provider, with said provider not necessarily anticipating equipping all these bins with such a solution.

Therefore, the inventors have attempted to develop a new solution for overcoming at least some of the disadvantages of the known solutions.

### AIMS OF THE INVENTION

The invention aims to provide a system and a method for monitoring enclosures for collecting loose waste, such as industrial or commercial waste.

In particular, the invention aims to provide, in at least one embodiment, a system and a method for automatically detecting the filling level of the collection enclosures.

In particular, the invention aims to provide a system and a method for automatically detecting the filling level of all types of collection enclosures, such as open waste containers, open collection bins, landfill cells, collection pits.

The invention also aims to provide, in at least one embodiment, a system and a method for simultaneously monitoring a collection area comprising a plurality of collection enclosures.

In particular, the invention aims to provide, in at least one embodiment, a system and a method for automatically detecting the type of collected waste and their proportions in the collection enclosure.

The invention also aims to provide, in at least one embodiment, a system and a method for notifying operators in the field in the event of collection errors.

The invention also aims to provide, in at least one embodiment, a system and a method for predicting the times conducive for transporting the waste from a collection enclosure.

The invention also aims to provide, in at least one embodiment, a system and a method for improving the carbon footprint of industrial or commercial activity generating waste.

The invention also aims to provide, in at least one embodiment, a system and a method that are easy to install and use.

### DISCLOSURE OF THE INVENTION

To this end, the invention relates to a system for monitoring at least one loose waste collection enclosure, such as a bin, a cell, a pit, comprising:
an image acquisition camera configured to be able to acquire, at a predetermined time interval, an image of an area where each collection enclosure to be monitored is arranged;
a unit for processing the images acquired by said camera.

The system according to the invention is characterized in that said processing unit comprises at least the following modules:
a module for detecting each collection enclosure present in said acquired images based on a first machine learning model trained to be able to detect collection enclosures, with this first learning module having been trained by means of a library of training images, called enclosure library, that included portions of images labeled as reflecting the presence of a collection enclosure and portions of images labeled as reflecting the absence of a collection enclosure;
a module for determining the type of waste present in each image portion detected by said enclosure detection module as being a collection enclosure, called enclosure images, based on a second trained machine learning model, with this second learning module having been trained by means of a library of training images, called waste library, that includes images of several types of waste likely to be collected in a collection enclosure;
a module for computing a filling rate of each collection enclosure by analyzing said enclosure images detected by said enclosure detection module.

Therefore, the system according to the invention mainly comprises a camera and an acquired image processing unit.

The camera is configured (field of view and orientation) so that it can image an area that encompasses at least the monitored enclosure, or even several monitored enclosures.

The processing unit comprises at least three distinct modules for analyzing images acquired by the image acquisition camera.

All the processing operations carried out by the three distinct modules are based on the same images, i.e., on the images acquired by the camera that are of an area where the one or more enclosures monitored by the system according to the invention is/are located, from the same perspective. No additional image provided by an additional sensor is required for the system according to the invention. Furthermore, no additional sensor, other than an image acquisition camera, is required for the system according to the invention.

The first module is a module for detecting the enclosures present in the images acquired by the camera. This module is therefore configured to extract, from the images acquired by the camera, sub-images that are each limited to a collection enclosure. These sub-images are referred to throughout the text as enclosure image. A collection area can include one or more enclosures and the image acquired by the camera can therefore include one or more enclosures. Thus, the first module can provide several images of enclosures from a single image acquired by the camera of the system according to the invention.

This first module implements a first machine learning model trained to detect the collection enclosures in the images. This learning model has been trained based on a library of training images (also called enclosure library throughout the text). This enclosure library is made up of images of various types of enclosures (bins, cells, pits, etc.) and each image of this enclosure library includes portions of images labeled as containing or not containing an enclosure. The portions of images labeled as reflecting the presence of a collection enclosure preferably include the limits of the collection enclosures. The machine learning model implemented by this first module can implement a supervised neural network.

The enclosure images detected by the enclosure detection module (also referred to as first module throughout the text) are then processed by the second module of the processing unit.

This second module is a module for determining the type of waste present in each enclosure image. The module is therefore configured to determine the type of waste present in the imaged enclosure by means of the enclosure image processed by this module. Such waste is made up of, for example, rubble, plastics, wood, cardboard, etc.

This second module implements a second machine learning model trained to detect the type of waste present in the image. This second learning module has been trained based on a library of training images (also referred to as waste library throughout the text) that includes a plurality of images of several types of waste likely to be collected in a collection enclosure. Each image of the waste library is labeled with the waste visible on the image. The machine learning model implemented by this second module can implement a supervised neural network. This second module therefore provides an indication of the waste present in each enclosure image.

The third module is a module for computing the filling rate of the enclosure. Therefore, this module is configured to provide a filling level for the enclosure. Thus, as soon as the filling level reaches a predetermined value, an operation for collecting the waste from the enclosure can be organized, for example by sending a notification to an item of equipment or an operator.

Advantageously, the module for computing the filling rate of each collection enclosure combines both the results of the analysis of the enclosure images detected by said module for detecting enclosures and the results of the type of waste identified by said module for determining the type of waste.

Thus, the system allows the proportion of the different waste to be known, by knowing the type of waste present in the enclosure based on the image provided by the second module, and by computing the filling rate. Indeed, with the system being configured to acquire images at a predetermined time interval, the invention allows the evolution of the filling of a container to be monitored, as well as the evolution of the filling according to the type of waste stored in the enclosure.

According to a variant of the invention, this third module implements a third machine learning model trained to detect the filling level.

This third learning model has been trained by means of a library of training images, called filling library, that includes a plurality of images of various enclosures accommodating various types of waste at various filling levels. Each image of the filling library is labeled with a filling level ranging between 0 and 100% full. The machine learning model implemented by this third module, according to this variant, can implement a supervised neural network.

According to another variant of the invention, this third module computes the filling rate by comparing at least one reference image corresponding to an empty enclosure with the image of said enclosure detected by said module for detecting enclosures. In other words, and according to this variant, the third module does not implement a trained learning model, but implements a comparison of the enclosure image originating from the first module with one (or more) reference image(s) corresponding to the empty enclosure.

The advantage of this variant is that it is no longer dependent on the training of a supervised neural network. Also, it does not depend on the labelling of the training images, which is a human activity that can therefore vary depending on the person responsible for labelling the images of the learning base. Furthermore, it allows the learning base (or filling library) that has to contain at least ten thousand images in order to be genuinely efficient to be dispensed with.

Advantageously, and according to this variant, said comparison of each reference image with said enclosure image involves detecting and identifying similar key elements between said two images, called image descriptors.

According to this variant, the third module compares the images based on image descriptors, which are the key points of the images. These descriptors are provided, for example, by a Scale Invariant Feature Transform (SIFT) algorithm. The implementation of this algorithm allows the filling areas of the enclosure to be identified, irrespective of the differences in brightness, shading, and positioning of the enclosure from one image to the next. The algorithm thus allows the key characteristics of the enclosure to be detected (for example, the boundaries and the edges of a container in the case of such an enclosure). The module for computing the filling rate can then determine the height of the waste in multiple areas of the container by determining the variations detected in the vicinity of these characteristic points.

According to another variant, the module for computing the filling rate at least partly combines the two previous variants, i.e., it implements a machine learning model trained to detect specific features of the image (for example, the image descriptors), associated with a comparison of the image with a reference image.

Advantageously, the system according to the invention further comprises a solar panel connected to said image acquisition camera in order to be able to supply it with electrical energy.

The system according to this variant is energy autonomous and can be easily installed in any location, irrespective of whether or not an electrical socket is present.

Advantageously, a system according to the invention comprises a mast mounted in said area where said collection enclosure is arranged, with said mast supporting said image acquisition camera.

This variant allows the camera to be installed in the vicinity of the enclosure to be monitored. According to another variant, the camera can be mounted on a wall or a structure present in the vicinity of the enclosure to be monitored.

The unit for processing acquired images can be partially or fully contained in the image acquisition camera or can be partially or fully formed by a server remote from said camera. In the case where the processing unit is fully or partially formed by a remote server, the system advantageously comprises wireless communication means configured to transmit said images acquired by said camera to said processing unit.

Advantageously, and according to this variant, said wireless communication means comprise at least 3G, 4G, 5G or Wi-Fi connectivity.

This connectivity not only allows the images from the camera to be transmitted to the processing unit, which is formed, for example, by a software application present on a remote server or by a set of software applications and databases present on a set of remote servers (also called cloud), but also allows instructions to be transmitted to the camera.

As a variant or in combination, it is also possible to implement wireless communication means that use low throughput connectivity, such as a Sigfox® or a LoRa® network or any equivalent network, for transmitting control data, for example.

Advantageously, and according to the invention, said predetermined time interval between two acquisitions of images by said camera depends on the evolution of the filling rate computed by said module for computing the filling rate and/or on the type of waste determined by said module for determining the type of waste.

The system according to this variant allows the image acquisition frequency to be adapted to the results provided by the processing unit. In particular, if the filling level rapidly increases, the acquisition frequency can be increased. Similarly, depending on the type of waste detected, the filling may need to be monitored more regularly. Other rules for adapting the acquisition frequency (and therefore the processing) can be provided as a function of the monitoring objectives.

Advantageously, a system according to the invention further comprises a module for assessing a mass and volume balance of the waste present in said enclosure.

According to this variant, the system can determine, based on the results provided by the module for determining waste and by the module for computing the filling rate, the mass and volume balance of the waste present in the enclosure. To this end, for each image analysis, the module for assessing the mass balance retrieves the information relating to the type of waste that is present and to the filling level. The module can therefore determine the mass balance and the corresponding mass volume therefrom.

The invention also relates to a method for monitoring at least one loose waste collection enclosure, such as a bin, a cell, a pit, etc., said method comprising:
acquiring images, at a predetermined time interval, of an area where each monitored collection enclosure is arranged;
processing the acquired images.

The method is characterized in that said image processing comprises:
detecting each collection enclosure present in said acquired images by inputting images into a first trained machine learning model, with this first learning model having been trained by means of a library of training images, called enclosure library, that included portions of images labeled as reflecting the presence of a collection enclosure and portions of images labeled as reflecting the absence of a collection enclosure, with the portions of images labeled as reflecting the presence of a collection enclosure including the limits of the collection enclosures;
determining the type of waste present in each image portion detected by said first learning model, by inputting each enclosure image into a second trained machine learning model, with this second learning model having been trained by means of a library of training images, called waste library, that includes images of several types of waste likely to be collected in a collection enclosure;
computing a filling rate of each collection enclosure by analyzing said enclosure images detected by said enclosure detection module.

The technical advantages and effects of the system according to the invention apply, mutatis mutandis, to a method according to the invention.

The invention also relates to a system and a method, characterized in combination by all or some of the features mentioned above or below.

### LIST OF FIGURES

Further aims, features and advantages of the invention will become apparent upon reading the following description, which is provided solely by way of a non-limiting example and which refers to the appended figures, in which:

FIG. 1 is a schematic view of a system according to one embodiment of the invention;

FIG. 2 is a functional schematic view of a processing unit of a system according to one embodiment of the invention;

FIG. 3 is a schematic view of an image acquired by a camera of a system according to one embodiment of the invention;

FIG. 4 is a schematic view of the image extracts provided by a module for detecting enclosures of a system according to one embodiment of the invention;

FIG. 5 is a schematic view of an image of a bin intended to be processed by the modules for detecting the type of waste and for computing the filling rate of a system according to one embodiment of the invention;

FIG. 6 is a schematic view of the images used by a module for determining the type of waste of a system according to one embodiment of the invention;

FIG. 7 is a schematic view of the images used by a module for computing the filling rate of a system according to one embodiment of the invention.

### DETAILED DESCRIPTION OF AN EMBODIMENT OF THE INVENTION

In the figures, the scales and proportions are not strictly followed for the sake of illustration and clarity. Furthermore, identical, similar, or comparable elements are designated using the same reference signs throughout all the figures.

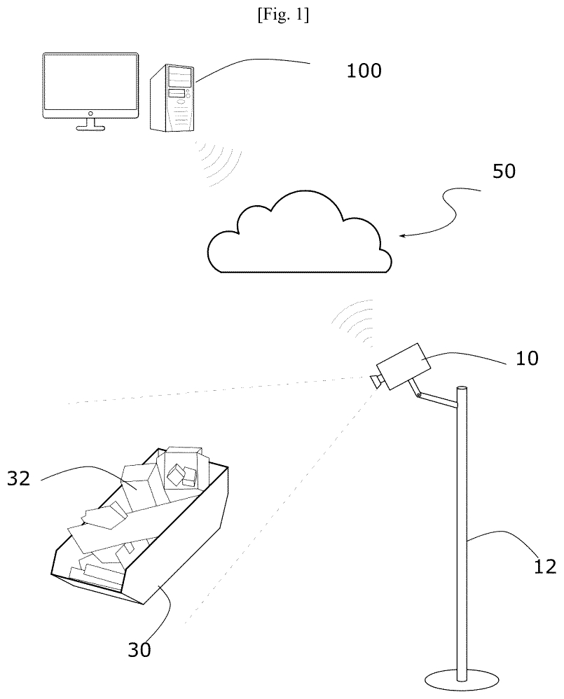

FIG. 1 illustrates a system according to one embodiment of the invention comprising a camera 10 for acquiring digital images of a waste storage bin 30 and a unit 100 for processing the digital images acquired by the camera 10. The images acquired by the camera 10 are transmitted to the processing unit 100 by a wireless communication network 50, which can be of any known type.

The embodiment described with reference to the figures comprises a processing unit formed by a server remote from the camera. That being said, according to other embodiments there is nothing preventing the processing unit from being partially or fully contained in the image acquisition camera.

The camera 10 can be of any known type. It preferably has a wide angle or a very wide angle (fish-eye camera) in order to be able to image a wide area that includes the storage bin 30 to be monitored. The camera is arranged at a distance from the bin, for example by being mounted on a structure, such as a post 12. This arrangement is implemented so that the camera 10 overhangs the bin 30 and can take an image of the bin 30 and of the waste 32 stored in the bin. In other words, the camera 10 is oriented toward the bin 30 so as to be able to take images of the inside of the bin.

The system according to the invention can monitor several enclosures simultaneously as long as they can be housed in the area covered by the image camera.

The acquisition of images is controlled by a control board housed in the camera 10. This control can involve, for example, adjusting the magnification of the camera, the acquisition frequency, the opening time and the ISO of the camera, etc.

The system further comprises a unit 100 for processing the images acquired by the camera 10. This processing unit 100 receives the images via wireless communication means 50 connecting the camera 10 and the processing unit 100.

In the embodiment of the figures, the processing unit is depicted as a remote server connected to the image acquisition camera via wireless communication means. That being said, according to other embodiments not shown in the figures, the processing unit can be partially or fully contained in the image acquisition camera.

This processing unit 100 comprises at least one processor, memories, and software routines able to implement the various processing modules described hereafter.

Hereafter, a “module” denotes a software element, a subset of a software program, which can be compiled separately, either for independent use, or in order to be assembled with other modules of a program, or a hardware element, or a combination of a hardware element and a software sub-program. Such a hardware element can include an application-specific integrated circuit (ASIC) or a field programmable gate array (FPGA) or a circuit of specialized microprocessors (better known as DSP (Digital Signal Processor)) or any equivalent hardware or any combination of the aforementioned hardware. In general, a module is therefore an element (software and/or hardware) for performing a function.

The processing unit 100 comprises three main modules: a module 110 for detecting the enclosures present in the acquired images, a module 120 for determining the type of waste present in each portion of an image detected by said detection module 110, and a module 130 for computing the filling rate of each enclosure.

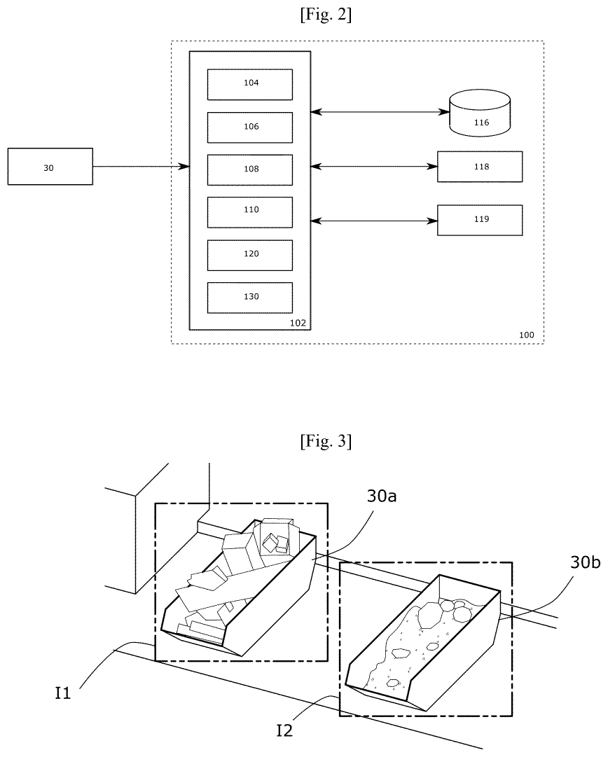

FIG. 2 is a block diagram of the processing unit 100 implemented by a system according to the invention.

The processing unit 100 comprises, for example, a computing device 102, which is to be understood in the broadest sense (computer, plurality of computers, virtual Internet server, virtual cloud server, virtual platform server, virtual local infrastructure server, server networks, etc.). This computing device typically comprises one or more processors 106, one or more memories 108, and a human-machine interface 104. The processing unit also comprises a database 116 for saving the results of the processing operations and for accessing information related to previous processing operations. For example, the database 116 can store the data relating to the processing operations of the previously acquired images of the bin being processed, thereby allowing, for example, the storage dynamics of the bin to be determined.

The processing unit 100 also comprises means for storing the trained learning models 118, 119 implemented by the invention. These means for storing the trained learning models can be servers remote from the equipment 102 or can be saved within the equipment 102.

The computing device 102 further comprises the detection module 110, the determination module 120 and the computation module 130. These modules notably use the processors 106, the memories 108, the database 116 and the means for storing the trained learning models 118, 119, in order to be able to be executed.

The machine learning models implemented by the invention can be of different types. They can be a supervised learning neural network, a support vector machine (SVM) or any other machine learning algorithm.

The module 110 for detecting enclosures present in the images acquired by the camera 100 implements a trained machine learning model 118 in order to detect collection enclosures in the images. The learning base (or enclosure library) used to train the model is made up of images of various types of enclosures (bins, cells, pits, etc.) with various orientations and various scales. Each image is labeled by a human operator by the type of enclosure it contains and by the boundary of the enclosure in the image. Training the model allows the model to automatically determine the areas where a collection enclosure is present in the image and the type of storage enclosures. The module 110 can then extract, from the image of the bin 30 provided by the camera 100, the area of the enclosure forming an image extract, called enclosure image. This enclosure image can be used by the module 120 for detecting the type of waste present in the enclosure.

In the event that several enclosures are simultaneously monitored by the same camera, the first module is used to detect all the monitored enclosures based on a single image provided by the image acquisition camera.

The system according to the invention allows any type of enclosure arranged in the field of view of the camera to be detected. Also, if the enclosure is replaced by another enclosure or is moved within the area imaged by the camera, the system continues to be functional, without needing to be informed of this enclosure change or of this enclosure movement.

It should be noted that, according to one embodiment, this module 110 for detecting enclosures also can be configured to determine the main dimensions of each detected enclosure, notably its width, its length and/or its height. To this end, the module can combine knowledge of a known reference dimension in the image that is obtained, for example, during an operation for calibrating the system, and knowledge of the field of view of the camera in order to deduce the dimensions of the enclosure detected in the image therefrom. This reference dimension is, for example, the length of a neighboring wall of the collection area. This reference dimension allows the area covered by a pixel of the camera to be deduced. It is therefore possible to deduce the dimensions of the edges of the enclosure therefrom based on the number of pixels occupied by these edges in the image. Furthermore, the enclosures generally have standardized dimensions and the system has a database of the most common enclosures. Also, the module 110 can compare the measured dimensions with those present in the database in order to confirm the measurements and/or to obtain the possible missing dimension (for example, the height, based on the measurement of the length and the width).

The module 120 for determining the type of waste present in each image extract implements a trained machine learning model 119 in order to detect the waste present on the image extract detected by the module 110. The learning base (or waste library) used to train the model is made up of images of various types of waste (cardboard, wood, plastics, etc.) likely to be present in a storage enclosure.

The image library was generated by the applicant by arranging image sensors on various types of collection enclosures (bin, cell, loose ground-based storage) each containing one or more of the types of waste to be identified. A collection enclosure can include a single type of waste (for example, a container dedicated to cardboard collection) or multiple types of waste (for example, a miscellaneous landfill waste container that can contain plaster, glass wool, shredded painted or unpainted wood, etc.)

On each image of the image library thus generated, the objects that are present are separately annotated using a segmentation approach. A label is assigned to each segmentation. In other words, each object of each image is labeled by a human operator, mentioning the type of waste that it represents. The training of the model allows the model to automatically determine the profiles of the objects present in the image and the types of waste present in the image.

The applicant also enhanced their learning base with the base known using the acronym TACO (available, for example, on the following website: http://tacodataset.org/). This image base contains multiple types of waste of any type in various environments. These images are manually labeled by operators. Other image bases also can be used to enhance the learning base, such as the following bases: “Domestic Trash Dataset”, “WaDaBa”, “Open litter map”.

The applicant has thus generated a learning base containing almost 80,000 images. However, it should be noted that the learning models can be trained with a smaller number of images, depending on the quality of the images and on the amount of waste present on each image.

According to an advantageous variant, the same image base is used for the module for detecting enclosures and for the module for determining the type of waste. The image library was generated by the applicant by arranging image sensors of a plurality of collection enclosures of various types (bin, cell, loose ground-based storage) each containing one or more of the types of waste to be identified.

On each image of the image library thus generated, each enclosure is separately annotated using a segmentation approach. A label is assigned to each segmentation. In other words, each enclosure of each image is labeled by a human operator, mentioning the type of enclosure.

In addition, like the procedure described for the waste library, the objects that are present on each image are separately annotated using a segmentation approach. A label is assigned to each segmentation. In other words, each object of each image is labeled by a human operator, mentioning the type of waste that it represents.

As previously indicated, the machine learning models implemented by the invention can be supervised learning neural networks, support vector machines, or any other machine learning algorithm. According to one embodiment, a convolutional neural network (known using the acronym CNN) is implemented for each learning model.

The learning is considered to be effective if it allows a predictive model to be defined that adapts both to the learning data and to the new images, not labeled. If the model does not adapt to the images of the learning base, the model is experiencing under-learning. If the model adapts to the images of the learning base too well and is not able to correctly classify the new images, the model is experiencing over-learning.

The learning phase aims to define the architecture of the neural network (number of layers, types of layers, no learning, etc.) and the associated parameters (weights of the layers and between the layers) that best model the various labels of the objects of the learning base and generate neither under-learning nor over-learning. This learning step of a neural network is known to a person skilled in the art, who can refer to the existing literature in order to obtain more details concerning the steps to be implemented to this end.

The module 130 for computing the filling rate of the bin 30 can either implement another machine learning model trained based on a learning base made up of images of various enclosures having various filling levels between 0 and 100%, or can compare a reference image with the image of the bin being analyzed.

The image library used for the module for detecting each enclosure and for the module for determining the type of waste also can be used for the module for computing the filling rate, by labeling each enclosure with a filling rate.

Preferably, the system compares the image extract with a reference image of the enclosure.

As described above, this comparison preferably implements an SIFT algorithm that allows the filling areas of the enclosure to be identified, irrespective of the differences in brightness, shading, and positioning of the enclosure from one image to the next. The algorithm thus allows the key characteristics of the enclosure to be detected (for example, the boundaries and the edges of a container in the case of such an enclosure). The module for computing the filling rate can then determine the height of the waste in a plurality of areas of the container by determining the detected variations in the vicinity of these characteristic points.

According to another variant, the module for computing the filling rate can at least partly combine the two previous embodiments. According to this variant, a machine learning model is trained to detect specific characteristics of the image, for example, the edges of the enclosures, and the comparison of images is used to compare the image with a reference image.

FIG. 3 is a schematic representation of an image acquired by the camera 100 at a given time. This image includes two bins 30a, 30b arranged adjacent to each other. The module 110 allows the two bins 30a and 30b to be detected and the sub-images I1, I2 to be extracted that each include a bin monitored by the system according to the invention.

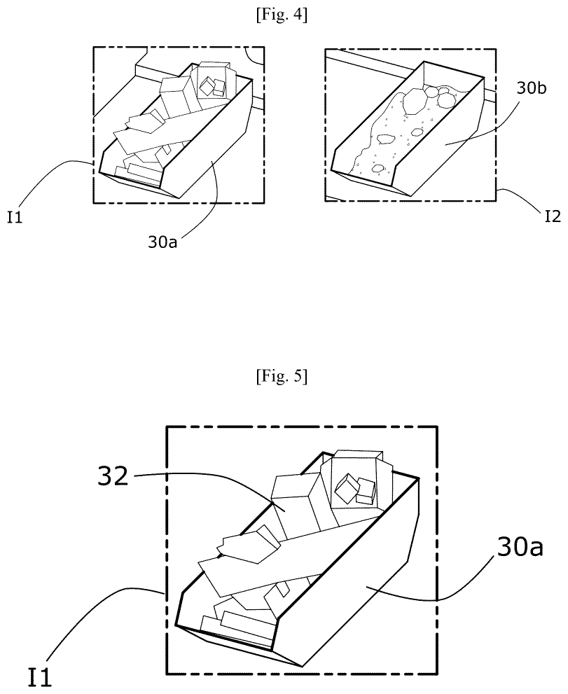

FIG. 4 schematically illustrates the two sub-images I1 and I2 respectively comprising the bins 30a and 30b extracted from the image acquired by the camera 100. The module 110 also can be configured, according to one embodiment, to anonymize the images I1 and I2 to ensure compliance with personal data protection regulations (more commonly known by the acronym GDPR).

The steps illustrated in FIGS. 3 and 4 are implemented by the module 110 for detecting enclosures in the image.

Each of these two sub-images I1 and I2 can then enter the module 120 for determining the type of waste and the module 130 for computing a filling rate. These steps are schematically illustrated by FIGS. 5, 6 and 7 in connection with the sub-image I1 of the bin 30a, with it being understood that each sub-image of an enclosure of each image acquired by the camera 10 is processed in the same way by the various modules of the monitoring system according to the invention.

FIG. 5 illustrates the sub-image I1 of the bin 30a intended to be processed by the module 120 for detecting waste and by the module 130 for computing a filling rate. The background of the image is removed so as to only keep the bin 30a and the waste 32 stored in the bin.

It should be noted that the running order of the modules 120 and 130 is not critical and that the filling rate can be computed first before determining the type of waste present in the bin 30a. That being said, throughout the remainder of the description it is anticipated that the type of waste is determined before the filling rate is computed.

The module 120 is configured to detect the type of waste 32 present in the image. As previously indicated, the module 120 uses the trained machine learning model 119, which allows it to detect the types of waste present on the sub-image I1 of the bin 30a.

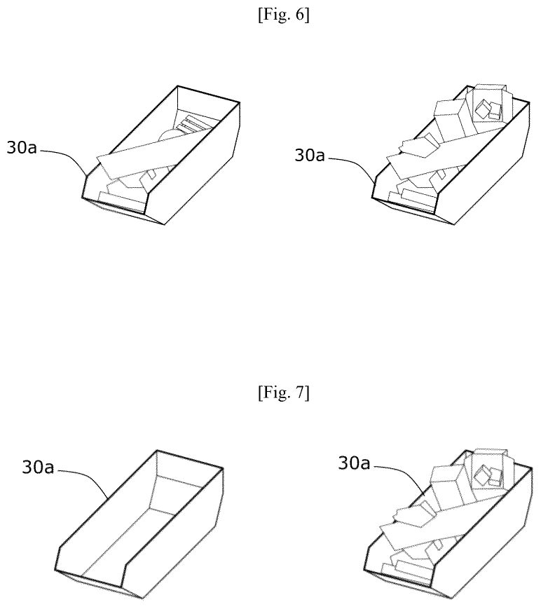

FIG. 6 illustrates another aspect of the processing carried out by the module 120. The right-hand view is the state of the bin 30a being processed and the left-hand view is the state of the bin 30a during the previous operation for acquiring images of the same bin 30a. These previous results are stored in the database 116, for example. Thus, the system can provide information concerning the variations in waste storage of the bin being analyzed. The system can therefore not only know the composition of the bin 30a at the time t, but can also know the filling dynamics and the filling times of this bin 30a. It is notably possible to know, if waste is detected that is not allowed in the considered bin, the period when this waste was added to the bin. The accuracy of the period will depend on the image acquisition frequency of the camera.

In order to specifically assess the waste added between the two images, the second machine learning module can be implemented to determine whether the content of the enclosure has evolved and/or if waste has been moved within the enclosure. It is then possible to use an algorithm, of the SIFT algorithm type described above, to more precisely detect the areas that have evolved between two images, and to cross-reference this information with the results of the analysis carried out by the machine learning module, in order to precisely know the waste that has been added between two images.

FIG. 7 schematically illustrates the principle of computing the filling rate of the bin 30a according to one embodiment of the invention.

The module 130 retrieves a reference image Iref of the bin 30a being analyzed from the database 116, with this reference image Iref being an image of the same type of an empty bin. This is the left-hand image of FIG. 7. The module 120 then computes the filling level of the bin of the right-hand image of FIG. 7 by comparing this reference image Iref with the image of the bin 30a by implementing the previously described SIFT algorithm.

The invention is not limited to only the embodiments that have been described. In particular, a person skilled in the art will easily determine the possibilities offered by a system according to the invention based on the various modules of the system. In particular, they will be able to assess the mass and volume balance of each bin, to forecast bin filling periods based on bin filling logs, etc. It is also possible to extend the waste detection and characterization routines to neighboring areas of the enclosures, such as the waste stored at the feet of the enclosures. This can be achieved by widening the analysis area of the image to the peripheries of the enclosure. It is also possible to detect any objects that block the removal of the enclosure (a vehicle parked in front of a collection bin, trenches dug around the bin, etc.). To this end, it is worthwhile enhancing the waste base used by the waste detection module with images of objects likely to hinder access to the enclosure. It is also possible to form a specific learning base and to implement an additional specific machine learning module for analyzing the peripheries of the storage enclosures.

The system has been described with an image acquisition camera in the visible domain. That being said, according to a variant of the invention, a multispectral camera can be used to obtain images of the waste in frequency bands other than the visible domain. In particular, an infrared camera can be used to obtain infrared images of the loose waste to be detected.

1. A system for monitoring at least one loose waste collection enclosure, said system comprising:
an image acquisition camera configured to be able to acquire, at a predetermined time interval, an image of an area where each collection enclosure to be monitored is arranged;
a unit for processing the images acquired by said camera; comprising at least the following modules:
a module for detecting each collection enclosure present in said acquired images based on a first machine learning model trained to be able to detect collection enclosures, with this first learning module having been trained by means of a library of training images, called enclosure library, that included portions of images labeled as reflecting the presence of a collection enclosure and portions of images labeled as reflecting the absence of a collection enclosure;
a module for determining the type of waste present in each image portion detected by said enclosure detection module as being a collection enclosure, called enclosure images, based on a second trained machine learning model, with this second learning module having been trained by means of a library of training images, called waste library, that includes images of several types of waste likely to be collected in a collection enclosure; and
a module for computing a filling rate of each collection enclosure by analyzing said enclosure images detected by said enclosure detection module.

2. The system as claimed in claim 1, wherein said module for computing the filling rate implements a third trained machine learning model, with this third learning model having been trained by means of a library of training images, called filling library, that comprises images of various enclosures accommodating various types of waste, each labeled with a filling level ranging between 0 and 100% full.

3. The system as claimed in claim 1, wherein said module for computing the filling rate compares at least one reference image corresponding to an empty enclosure with said image of said enclosure detected by said enclosure detection module.

4. The system as claimed in claim 3, wherein said comparison of said reference image with said enclosure image involves detecting and identifying similar key elements between said two images, called image descriptors.

5. The system as claimed in claim 1, further comprising a solar panel connected to said image acquisition camera in order to be able to supply it with electrical energy.

6. The system as claimed in claim 1, further comprising a mast mounted in said area where said collection enclosure is arranged, with said mast supporting said image acquisition camera.

7. The system as claimed in claim 1, wherein said predetermined time interval between two acquisitions of images by said camera depends on the evolution of the filling rate computed by said module for computing the filling rate and/or on the type of waste determined by said module for determining the type of waste.

8. The system as claimed in claim 1, further comprising a module for assessing a mass and volume balance of the waste present in said enclosure.

9. The system as claimed in claim 1, wherein said processing unit is formed by a server remote from said camera and in that it further comprises wireless communication means configured to transmit said images acquired by said camera to said processing unit.

10. The system as claimed in claim 9, wherein said wireless communication means include at least 3G, 4G, 5G or Wi-Fi connectivity.

11. A method for monitoring at least one loose waste collection enclosure, said method comprising:
acquiring images, at a predetermined time interval, of an area where each monitored collection enclosure is arranged;
processing the acquired images;
characterized in that said image processing comprises:
detecting each collection enclosure present in said acquired images by inputting images into a first trained machine learning model, with this first learning model having been trained by means of a library of training images, called enclosure library, that included portions of images labeled as reflecting the presence of a collection enclosure and portions of images labeled as reflecting the absence of a collection enclosure, with the portions of images labeled as reflecting the presence of a collection enclosure including the limits of the collection enclosures;
determining the type of waste present in each image portion detected by said first learning model, by inputting each enclosure image into a second trained machine learning model, with this second learning model having been trained by means of a library of training images, called waste library, that includes images of several types of waste likely to be collected in a collection enclosure; and
computing a filling rate of each collection enclosure by analyzing said enclosure images detected by said enclosure detection module.
